(19) United States
(12) Patent Application Publication
(10) Pub. No.: US 2003/0113530 A1
(43) Pub. Date: Jun. 19, 2003

(54) Low density oriented strand boards and methods of manufacturing same

(76) Inventors: Andrew T. Go, Kirkland (CA); Elizabeth Cacchione, St. Lambert (CA)

Correspondence Address: Santosh K. Chari, Orange & Chari, Suite 4900, 66 Wellington Street West, Toronto, ON, M5K 1H6, CA

(21) Appl. No.: 10/209,277

(22) Filed: Aug. 1, 2002

(30) Foreign Application Priority Data
Aug. 2, 2001 (CA) 2,354,640

(51) Int. Cl. B32B 5/16

(52) U.S. Cl. 428/326; 427/214; 428/338

(57) ABSTRACT

A method for forming an oriented strand board comprises forming a laminate of mats of wood flakes covered with a resin and pressing the laminate under heat. The laminate comprises a core layer laminated to two surface layers. The flakes are bound together with a resin comprising phenol formaldehyde (PF) or polymeric methylene di-isocyanate (MDI).

### BACKGROUND OF THE INVENTION

1. Field of the Invention

The present invention relates to a method of manufacturing panels or boards composed of wood material. More specifically, the invention provides a method of manufacturing oriented strand boards of lower density.

2. Description of the Prior Art

Wood based construction, either in residential or commercial environments, is very popular in North America and other parts of the world. In such construction, wood boards or panels are often used in sheathing the building or for other structural purposes. Such panels, are commonly provided in 4×8′ sheets. Plywood is one example of such a panel. Plywood is formed from veneer sheets of wood peeled off from logs and laminated together to form the panels. Plywood panels have densities almost equivalent to that of the wood itself and high strength characteristics. However, the cost of plywood is high due to the amount of wood material used in its formation.

Another example of the above panels are oriented strand boards (OSB), which are formed by layering strands, or flakes of wood mixed with a resin or binder and subjecting the layers to heat and pressure. Since OSB panels are made from pieces of wood that are chipped off from logs, there is less waste material as compared to plywood and, therefore, such panels have a lower material cost. However, one drawback that has been found lies in the increased density of such boards due to the amount of resin required to achieve the required strength characteristics. Examples of such OSB products are provided in the following U.S. Pat. Nos. 4,246,310 (Hunt et al.); 4,610,913 (Barnes); 5,506,026 (Iwata et al.); and, 5,736,218 (Iwata et al.).

The typical density of an OSB panel is in the range of 38 to 40 lbs/ft³ (pcf) and is considerably higher than that of plywood, which is typically in the range of 28 to 32 pcf. In the result, the weight of OSB panels is also considerably greater, which causes various problems when such boards are used in construction. Although the prior art, such as that mentioned above, describes various attempts to provide a low density OSB, the resulting board often has reduced structural integrity and strength.

Thus, the present invention provides a method for producing a “low density” OSB while still preserving the desired strength characteristics.

### SUMMARY OF THE INVENTION

In a preferred embodiment, the present invention provides a method of producing an oriented strand board panel comprising:

a) providing first wood flakes having a first thickness;

b) providing second wood flakes having a second thickness, wherein the second thickness is greater than the first thickness;

c) adjusting the moisture content of the first wood flakes to between 6 and 12 wt % and of the second wood flakes to less than 9 wt %;

d) mixing the flakes with a resin;

e) forming a first mat with the first wood flakes;

f) forming a second mat, over the first mat, with the second wood flakes;

g) forming a third mat, over the second mat, with the first wood flakes, whereby a three layer composite mat is formed; and

h) pressing and heating the layers of mats in a press.

In another embodiment, the invention provides an oriented strand board comprising:

two surface layers composed of first wood flakes;

a core layer composed of second wood flakes, the core layer being between and laminated to the two surface layers;

wherein:

the density of the board is less than about 35 pounds/ft³;

the thickness of the core layer comprises about ⅓ of the total thickness of the board;

the first wood flakes are about 3″-6″ long, 1″-2″ wide, and 0.018″-0.025″ thick; and,

the second wood flakes are about 3″-6″ long, 1″-1.5″ wide, and 0.025″-0.035″ thick.

### BRIEF DESCRIPTION OF THE DRAWINGS

These and other features of the preferred embodiments of the invention will become more apparent in the following detailed description in which reference is made to the appended drawings wherein:

FIG. 1 is a cross sectional elevation view of an OSB panel according to an embodiment of the present invention.

### DESCRIPTION OF THE PREFERRED EMBODIMENTS

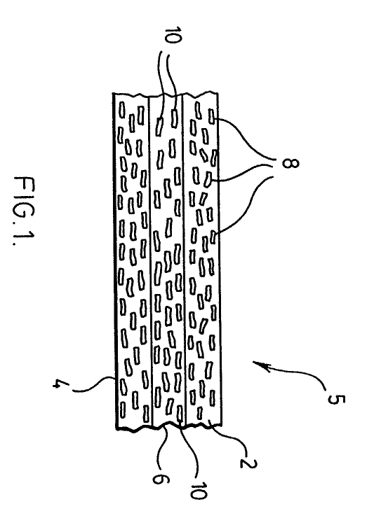

An OSB panel according to the present invention is illustrated in FIG. 1. It will be understood that FIG. 1 is used solely to illustrate the invention and that it is not intended to limit or reflect the scale or dimensions of the board or the components thereof.

As shown in FIG. 1, the board 5 is comprised of at least 3 layers. The board 5 includes a core layer 6 that lies between a pair of face layers 2 and 4. Each of the facing layers 2 and 4 and the core layer 6 are comprised of wood chips or flakes 8 and 10, respectively.

In accordance with the preferred embodiment of the invention, the flakes 8 of the face layers 2 and 4 are thinner than the flakes 10 of the core layer 6. In the preferred embodiment, the flakes 8 of the faces 2 and 4 are slightly longer than those 10 of the core 6. For example, in a preferred board, the flakes of the faces have a length of approximately 5″-5.75″ while that of the core flakes is approximately 4″-4.5″. According to the preferred embodiment, the flakes of the OSB panels have the following general dimensions:

| Layer | Length (in.) | Width (in.) | Thickness (in.) |
|---|---|---|---|
| Faces | 3-6 | 1-2 | 0.018-0.025 |
| Core | 3-6 | 1-1.5 | 0.025-0.035 |

The flakes 8 in the face layers 2 and 4 are preferably oriented so that the lengths of the flakes are generally aligned with the length of the board. For the core layer 6, the flakes 10 are preferably aligned so that the lengths are generally perpendicular to that of the flakes of the face layers.

OSB panels made according to the present invention have densities that are generally less than 35 pcf (pounds per cubic foot) and, generally, between 28 and 32 pcf. Preferably, the OSB of the invention is made from flakes of Aspen, as is typically used in the art, or other woods of similar characteristics. It will be understood that the above density values of the boards of the invention are based on the use of Aspen flakes and that slight variations will be encountered when flakes of other wood are used due to the inherent difference in the densities of the wood.

The total thickness of the OSB according to the present invention comprises 30%-35% of the core layer 6 and 65%-70% of the two face layers. In a preferred embodiment, the core layer 6 makes up about 36% of the total thickness of the board, while the face layers make up 64% of same (i.e. each of the face layers comprises 32% of the total thickness). Further, the preferred total thickness of the OSB is 7/16″, which is the common thickness of 4′×8′ boards used in construction. It will be understood, however, that the thickness of the board can be varied if needed.

The binder or resin used to adhere the various flakes of the board are generally known in the art. Preferably, the resin used in the present invention is either MDI (polymeric methylene di-isocyanate) or PF (phenol formaldehyde). The PF resin may be provided in liquid (LPF) or powder (PPF) form or a combination of both. In the case of MDI, the resin is added in liquid form and the preferred amount of resin is 2%-4.5% (wt % based on weight of wood flakes) and, more preferably 2.5%-3%. In the case of PF, the preferred amount of resin is 2%-6% (wt %), and, more preferably 6%. As described below, according to the preferred embodiment, the PF resin is provided in both powder and liquid forms in the following proportions: ¾ PPF and ¼ LPF. Therefore, as will be understood, if the total amount of PF added is 6%, the liquid component of PF comprises 1.5% and the powder component comprises 4.5% of the total.

According to the present invention, in addition to dimensional variation, the flakes 8 and 10 of the OSB will also have different moisture contents, which will depend upon the resin that is used. In the preferred embodiment, the moisture contents of the flakes are as follows:

| | Moisture content (wt %) | |
|---|---|---|
| | MDI | PF |
| Face Layers | 9%-12% | 6%-9% |
| Core Layer | 6%-9% | ≦(3%-4%) |

In the case of MDI resin, the difference between the surface and core moisture content should preferably be at least 3%.

In the manufacture of OSB according to the preferred embodiment, a wax is also added to the flakes to impart water repellency. Such waxes are known in the art.

In the preferred embodiment, the following steps are followed in the manufacture of the OSB described above:

1) the water content of the flakes is adjusted as indicated above.

2) wax is added.

3) the resin is added.

4) the layers are then pressed and subjected to heat.

As indicated above, in the case where PF is used as the resin, the resin is added as ¾ powder (PPF) and ¼ liquid (LPF). Further, in the preferred embodiment, and where PF is used, the liquid component is added before the powdered component. The minimal amount of liquid PF resin is used to retain the powder component on the flakes. The present inventors have found that where only powder PF resin is applied the board's bending strength is impaired. This is illustrated in the examples below.

Preferably, the pressing is conducted using a “Fast Close” method wherein, as is known in the art, the press is closed rapidly. For example, in the case where a 7/16″ thick board is to be formed, the press is “fast closed” in preferably less than 30 seconds and typically 15 to 30 seconds. As will be understood by persons skilled in the art, the press closing times will vary for boards of other thicknesses. It is known in the art that a fast close method results in higher bending strengths of the boards. However, it is also know in the art that such a method also compromises the internal bond (IB) strength between the flakes. However, it has been found, as illustrated in the examples below, that the method of the present invention offers an advantage in that there is no reduction in IB strength even though a “fast close” method is used. It is believed that the reason for this benefit in maintaining IB strength stems from the higher resin coverage of the thicker flakes. In other words, the reduced surface area to weight ratio of the flakes (due to the use of thicker flakes) of the present invention leads to an increase in resin coverage. Thus, the use of thicker flakes in the present invention leads to an added benefit by allowing the use of the fast close press method while retaining desired IB strength values. In accordance with the preferred embodiment of the present invention, IB values of at least 40 psi are achieved.

The press used for forming the boards is conventionally known in the art. The press typically includes opposing platens that are heated to a desired temperature. Both the temperature and pressing (or “cooking”) time will depend on the resin used. For example, the following conditions are preferred for the present invention:

| | Pressing Time (seconds) | Pressing Time (seconds) |
|---|---|---|
| Resin | At Press Temperature of 200° C. | At Press Temperature of 230° C. |
| MDI | 80 | 120 |
| PF | 80 | 45-55 |

It will be understood that other temperatures and press times are also possible depending upon the thickness of the desired board and other factors.

In the preferred embodiment, the layers of flakes are sprayed with a fine mist containing 0.8% to 1.5% water, prior to pressing. Preferably, the mat is covered with 50-75 g/m² of water. Such a spraying helps to develop the internal bond of the panel thereby reducing the amount of resin needed to form the board. In the result, the density of the board is also reduced.

The invention is further illustrated by the following examples. The examples are not intended to limit the scope of the invention.

### EXAMPLES

Aspen logs were waferized to specific flake dimensions for the core and surface layers. The face layers consisted of wafers which were 5.75″ long by 0.020″-0.025″ thick by no more than 1″-2″ wide, while the core layer was composed of wafers which were 4.5″ in length by 0.030″-0.035″ thick by 1″-1.5″ wide.

The water content in the flakes was adjusted to 9% to 12% in the face and 6% to 9% in the core layers wherein the percentage of water was measured on a weight basis based on the weight of the wood material. A moisture content differential of at least 3% was maintained between the face and core layers. In the case of PF resin, the flakes were prepared by: (1) adjusting the water content as indicated above; (2) adding a wax; (3) adding the liquid PF component; and (3) adding the powder PF component. The resin components were added through a series of spinning discs. This enabled obtaining a tight resin distribution, which is important in reducing density with a powdered phenolic resin.

The panel was formed in 3 cross-oriented layers. The face layers comprised 65-75% of the total thickness of the mat, while the core layer comprised the remaining 25-35%.

The mat was sprayed with 0.8% to 1.5% water in a fine mist. This was found to assist in developing the internal bond of the panel and to reduce resin usage.

The pressing strategy, which is believed to be important in reducing panel density, was a “fast close” method wherein the press was closed in 15-30 seconds for a 7/16″ panel. Following this, a press, or cook time of 120 seconds was used for PF, or 45-55 seconds for MDI at a press temperature of 230° C. It will be understood that the required press time will vary depending upon the press temperature. Therefore, at lower temperatures, a longer press time will be required. For example, in the case of MDI resin, the press time would be extended to 80 seconds for a press temperature of 200° C. The effect of temperature on the press time is shown in Table 2 below, along with its effect on board properties. Following pressing, a total of 10 seconds or less is required for panel degas according to the present invention as compared to very dense panels (i.e. having a density greater than 38 lb/ft3) where typically 30 seconds is required for degas. With the present invention, the press mat pressure is reduced by 35-40% due to lower compaction requirements.

The results of the above experiments are provided in the following Tables.

TABLE 1
7/16″ × 4′ × 8′ panel production at 210° C.:
Face/Core ratio: 64/36

| | MOE | MOE | MOR | MOR | Internal | Face/Core | | Press | |
|---|---|---|---|---|---|---|---|---|---|
| Density | (par) | (perp.) | (par.) | (perp.) | Bond | moisture | Resin | Time | |
| (lb/ft³) | kPsi | kPsi | psi | psi | (IB)(psi) | wt % | loading | (sec) | Resin Type |
| 31 | 832 | 237 | 4,940 | 2,150 | 45 | 9 and 3.5 | 1.5% LPF + | 160 | Powder and Liquid-Phenol |
| | | | | | | | 4.5% PPF | | Formaldehyde (PPF and LPF) |
| 32 | 943 | 261 | 5,240 | 2,190 | 46 | 9 and 3.5 | 1.5% LPF + | 160 | Powder and Liquid-Phenol |
| | | | | | | | 4.5% PPF | | Formaldehyde |
| 33 | 909 | 261 | 5,050 | 2,100 | 48 | 9 and 3.5 | 1.5% LPF + | 160 | Powder and Liquid-Phenol |
| | | | | | | | 4.5% PPF | | Formaldehyde |
| 30 | 783 | 193 | 4,750 | 1,740 | 50 | 9 and 5.5 | 3.0% | 130 | MDI |
| 31 | 788 | 237 | 4,330 | 2,080 | 47 | 9 and 5.5 | 3.0% | 130 | MDI |
| 32 | 735 | 300 | 4,530 | 2,590 | 54 | 9 and 5.5 | 3.0% | 130 | MDI |
| Standard | 800 | 225 | 4,200 | 1,800 | 50 | | | | |
| Control | 788 | 290 | 3,450 | 1,990 | 31 | 6 and 5 | 2.5% | 160 | 100% Powder Phenol |
| 38 | | | | | | | | | Formaldehyde |
| Control | 493 | 213 | 1,770 | 1,280 | 15 | 6 and 5 | 2.5% | 160 | 100% Powder Phenol |
| 31 | | | | | | | | | Formaldehyde |

Notes:
MOE—modulus of elasticity (measured in perpendicular (perp) or parallel (par) directions).
MOR—modulus of rupture.
“Standard”—refers to generally acceptable standards for boards.

TABLE 2
Effect of Temperature and Moisture Content on Press Time
The following tests were conducted to investigate the effect of press
temperature and moisture content of the furnish on the press time. For
each trial a sample panel having dimensions 7/16″ × 3′ × 3′ was used,
each of which had a density fixed at 38 lbs/ft³. The resin used was MDI
in the amount of 3 wt %. The face/core ratio of each panel was 50/50 and
for each the flakes were not oriented. The furnish was wetted with water
in the amount of 0.8 wt % prior to pressing.

| | Moisture (Face/Core) | Press | IB | MOE | MOR |
|---|---|---|---|---|---|
| Temperature | wt % | Time | (psi) | (kPsi) | (psi) |
| 200 | 11 & 6.5 | 120 | 47 | 667 | 4,100 |
| 230 | 11 & 6.5 | 120 | 75 | 875 | 5,350 |
| 200 | 11 & 6.5 | 100 | 25 | 759 | 4,360 |
| 230 | 11 & 6.5 | 100 | 50 | 760 | 5,000 |
| 200 | 9 & 6 | 120 | 46 | 672 | 4,110 |
| 230 | 9 & 6 | 120 | 73 | 740 | 5,200 |
| 200 | 9 & 6 | 100 | 23 | 610 | 3,900 |
| 230 | 9 & 6 | 100 | 45 | 670 | 4,700 |

TABLE 3
Effect of Water Addition on Mat:
The following data provides information on the effect of applying water
on the furnish prior to pressing (i.e. as a spray as described above). In
the following trials, the density of each panel was fixed at 35 lb/ft³ and
2.5 wt % MDI resin was used. The press temperature was set at 215° C.
and the total press time was 130 seconds. For the panels, a Face/Core
ratio of 64/36 was used and wherein the moisture content for the face
and core layers was adjusted to 8% and 6%, respectively. The first
column indicates the amount of water added based on the weight of the
wood flakes. Each of the panels was of the same size as in table 2.

| Water | IB | MOE (par) | MOE (perp) | MOR (par) | MOR (perp) |
|---|---|---|---|---|---|
| (wt %) | psi | kPsi | kPsi | psi | psi |
| 0 | 10 | 1,001 | 198 | 4030 | 1920 |
| 0.8-1 | 47 | 1,117 | 222 | 6030 | 1820 |
| 1.2-1.5 | 71 | 1,194 | 237 | 6130 | 2070 |

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method of producing an oriented strand board panel comprising:
a) providing first wood flakes having a first thickness;
b) providing second wood flakes having a second thickness, wherein said second thickness is greater than said first thickness;
c) adjusting the moisture content of said first wood flakes to between 6 and 12 wt % and of said second wood flakes to less than 9 wt %;
d) mixing said flakes with a resin;
e) forming a first mat with said first wood flakes;
f) forming a second mat, over said first mat, with said second wood flakes;
g) forming a third mat, over said second mat, with said first wood flakes, whereby a three layer composite mat is formed; and
h) pressing and heating said layers of mats in a press.

2. The method of claim 1 wherein said first and second flakes are further mixed with a wax prior to step (e).

3. The method of claim 2 wherein said wax is added between steps (c) and (d).

4. The method of claim 1 wherein said composite mat is wetted prior to pressing and heating.

5. The method of claim 4 wherein the amount of water used for said wetting is between 0.8 and 1.5 wt %.

6. The method of claim 1 wherein said resin is phenol formaldehyde (PF) or polymeric methylene di-isocyanate (MDI).

7. The method of claim 1 wherein said resin is phenol formaldehyde (PF) and said resin is added in liquid and powder forms.

8. The method of claim 7 wherein the PF resin comprises 25% liquid PF and 75% powder.

9. The method of claim 8 wherein said liquid PF resin component is added prior to said powder PF resin component.

10. The method of claim 1 wherein, in said pressing step, composite mat is placed in the press and the press is closed in less than 30 seconds.

11. An oriented strand board comprising:
two surface layers composed of first wood flakes;
a core layer composed of second wood flakes, said core layer being between and laminated to said two surface layers;
wherein:
the density of said board is less than about 35 pounds/ft³;
the thickness of said core layer comprises about ⅓ of the total thickness of said board;
said first wood flakes are about 3″-6″ long, 1″-2″ wide, and 0.018″-0.025″ thick; and,
said second wood flakes are about 3″-6″ long, 1″-1.5″ wide, and 0.025″-0.035″ thick.

12. The board of claim 11 wherein said flakes are adhered together with a PF or MDI resin.

13. The board of claim 12 wherein the density of said board is between 28 and 32 pounds/ft³.

14. The board of claim 13 wherein said board has an internal bond (IB) strength of at least 40 psi.
